(19) United States
(12) Patent Application Publication
(10) Pub. No.: US 2006/0126144 A1
(43) Pub. Date: Jun. 15, 2006

(54) Optical microscanning system and method with embedded scannable photo-pumped light source

(76) Inventor: Qingwei Mo, Austin, TX (US)

Correspondence Address: HULSEY+ Intellectual Property Lawyers, P.C., Building. 3. Suite 610, 1250 S. Capital of Texas Highway, Austin, TX, 78746, US

(21) Appl. No.: 11/008,077

(22) Filed: Dec. 9, 2004

(51) Int. Cl. G02B 26/08

(52) U.S. Cl. 359/196

(57) ABSTRACT

An optical microscanning system for selectively emitting a highly coherent, collimated, and monochromatic beam of light (122) in a desired trajectory and selectively redirecting the trajectory within a scan field. The system includes a fixed light source (112) of substantially coherent, collimated, and monochromatic light (118) and an optically pumped light source (120) of highly coherent, collimated, and monochromatic light (122). The optically pumped light source (120) is optically pumped by the fixed light source (112). The optically pumped light source (120) can selectively redirect its light output (122). Also, a method of manufacturing such an optical microscanning system. A cavity is etched (156) in a base substrate. Two electrodes are provided (158) at the cavity floor. A second layer is provided (160) over the mouth of the cavity. A mirror layer is bonded (162) onto the second layer. Spacers are etched (164) through the mirror layer and second layer to define a substrate section (165). The mirror layer is etched to define a mirror (166).

### TECHNICAL FIELD OF THE DISCLOSURE

This disclosure pertains to image projection systems and methods. More particularly, this disclosure relates to microscanning systems and methods.

### BACKGROUND OF THE DISCLOSURE

A prior art light source device emits an output light beam using an electrically pumped light source. Accordingly, the device's light source must be provided with electricity in order to operate. Electrodes and wires are conventionally required to provide electricity to such devices. The electrodes are required to be fixed relative to the light source. Such constraints have prevented the redesign of such devices to enable scanning of the light source itself according to one or more axes through or highly proximate to the light source.

A two-mirror solution is now quite prevalent. No prior art approach places the light source directly on a scanning mechanism with one or more axes of rotation through or highly proximate to the light source. One approach places a light source at one end of a moving arm, depicted in FIG. 1. Laser 102 is mounted at one end of articulating arm 104, enabling the device to scan the output beam. However, this approach necessitates a certain amount of length in the device which can hinder applications favoring laterally dense arrangement of multiple light source devices.

The prior art approaches have all provided a fixed placement for the light source. Such fixed placement facilitated use of electrically pumped light sources provided with the requisite electrical pumping via traces connected to the light source. The presence of connective traces would have prevented the light sources from being scanned accurately and precisely, but this was not a problem because the light sources were fixed.

The prior art includes a two-mirror light source approach. A light source fixed in a substrate directs a light beam to a first mirror which can be selectively scanned according to a first axis. The first mirror reflects the beam to a second mirror which can be selectively scanned according to a second axis orthogonal to the first. The second mirror reflects the beam which is then emitted from the two-mirror light source. Conventionally, the two-mirror approach has not been implemented as a single chip device. As a practical matter, serious integration issues have been encountered in attempting to implement the two-mirror approach. A spacer or other mechanism has been necessary to maintain each mirror in fixed position relative to the other mirror and to the light source. Furthermore, the need to maintain fixed relative orientation between the mirrors and light source has created alignment issues.

FIG. 2 depicts a typical implementation of the two-mirror approach. A bank of red, green, and blue lasers 106 is located and fixedly oriented toward a first mirror 108 which is scannable along a first axis. The reflected beam is thence directed toward a second mirror 110 which is scannable along a second axis, orthogonal to the first axis.

The problems of the two-mirror approach are significantly reduced by aligning an EP light source with an OP light source so that the EP light source emission pumps the OP light source, and scanning the OP light source as desired to selectively direct the output light beam. As a practical matter, the scale of precision required is sub-millimeter.

Integrated circuit (IC) packaging is very expensive. For example, more than 50% of the cost of current Intel Pentium processor ICs is in their packaging. The relatively high cost of IC packaging is driven by the continuous exponential shrinking of IC technology.

The cost of packaging is also exacerbated in applications requiring particularly close tolerances, such as digital mirror devices and other light projection applications in which particular light sources must be aligned with micromirrors in order to accurately project a pixel onto a distant screen. In such applications, a reduction in the amount or complexity of packaging would provide significant cost savings. Prior art devices have form factors, including IC packaging, in the range of 2-3 cm.

### BRIEF DESCRIPTION OF THE DRAWINGS

For a more complete understanding of the present disclosure, and the advantages thereof, reference is now made to the following brief descriptions taken in conjunction with the accompanying drawings, in which like reference numerals indicate like features.

FIG. 1 depicts a prior art cantilever light source device.

FIG. 2 depicts a prior art two-mirror light source.

FIG. 3 schematically depicts an integrated light source, according to an embodiment of the present invention.

FIG. 4 schematically depicts an electrically pumped light source (EP light source), according to an embodiment of the present invention.

FIG. 5 schematically depicts a scanning mechanism, according to an embodiment of the present invention.

FIG. 6 shows a scanning electron microscope view of a scanning mechanism, according to an embodiment of the present invention.

FIG. 7 schematically depicts an integrated light source having a transparent spacer between an electronically pumped light source and an optically pumped light source, according to an embodiment of the present invention.

FIG. 8 schematically depicts an integrated light source having an opaque spacer between an electronically pumped light source and an optically pumped light source, according to an embodiment of the present invention.

FIG. 9 depicts a flowchart of a method of manufacturing an integrated light source, according to an embodiment of the present invention.

FIGS. 10, 11, and 12 schematically depict a method of manufacturing an integrated light source, according to an embodiment of the present invention.

FIG. 13 schematically depicts an integrated light source, according to an embodiment of the present invention.

FIG. 14 schematically depicts various scan fields, according to embodiments of the present invention.

FIG. 15 schematically depicts the provision of current to electrodes driving an electrically pumped light source and the control of an integrated light source with an application specific integrated circuit (ASIC), according to an embodiment of the present invention.

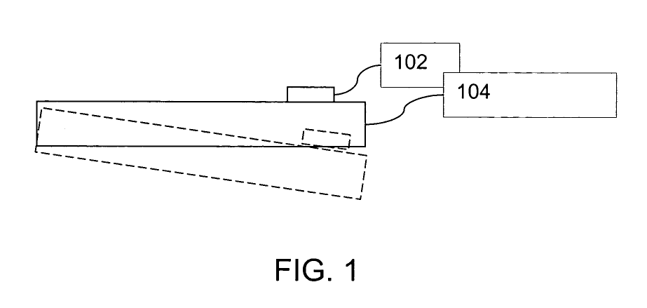

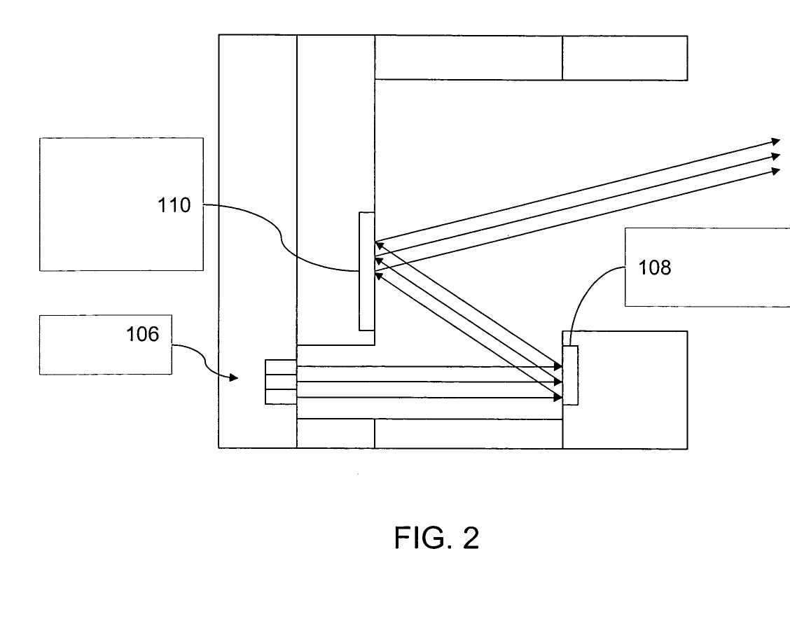

### DETAILED DESCRIPTION

The teachings of this disclosure, which fall within the scope of the appended claims, can be applied to solve several important commercial and technical problems. Retinal, fingerprint, and other biometric scanning applications rely upon precise optical scanning systems. Breast cancer diagnostic and other biological scanning applications take advantage of the altered optical properties of cancerous and precancerous tissues as contrasted with those of healthy tissues to provide very early condition detection. Infrared light and near-infrared light appear to be particularly promising wavelengths in this regard. Compactness and portability of devices embodying the present invention facilitate versatility in medical field applications.

A class of counterterrorism techniques includes optical scanning of luggage and other potential carriers for biological and chemical weapons. Biological and chemical compounds used in some of these weapons of terror are readily detectible by optical scanning. For example, some such compounds exhibit an optical response to UV radiation by emitting a characteristic blue or green sheen. Currently common devices now in use in airports are very large and practically immobile, requiring luggage and other items to pass through set locations for screening. If such devices were made more compact and lighter weight, they would be more portable, allowing the performance of screening at varying locations rather than only at set locations. Such varying of screening location would improve the effectiveness of security against terrorist weapons employing optically detectible biological and chemical compounds.

This disclosure provides an optical microscanning system for selectively emitting a highly coherent, collimated, and monochromatic beam of light in a desired trajectory and selectively redirecting the trajectory within a scan field. The system includes a fixed light source of substantially coherent, collimated, and monochromatic light and an optically pumped light source of highly coherent, collimated, and monochromatic light. The optically pumped light source is relatively positioned and configured to be optically pumped by the highly coherent, collimated, and monochromatic light output of the fixed light source. The optically pumped light source has a scan range within which it is adapted to be scannably reoriented in order to selectively redirect the highly coherent, collimated, and monochromatic light it emits.

The fixed light source can be a vertical cavity surface emitting laser (VCSEL), and can be composed of stacks of aluminum gallium arsenide and gallium arsenide substrates and be configured to emit a beam of light to which silicon is transparent. The VCSEL can also include indium gallium arsenide and be configured to emit a beam of light having a 1.3 micron wavelength. Furthermore, the optical microscanning system can include a scanning mechanism defining the scan range of the optically pumped light source according to one or more axes of reorientation.

A spacer can be included between the fixed light source and the optically pumped light source for fixing the relative positions of the fixed and optically pumped light sources. The spacer can be composed of a material transparent to the light emitted by the fixed light source. Alternately, the spacer can be composed of a material opaque to the light emitted by the fixed light source, in which case the spacer must include a hole through which the light emitted by the fixed light source can pass to pump the optically pumped light source.

Multiple optical microscanning systems can be arranged in a bank, wherein each optical microscanning system is configured to emit light having a different wavelength. In particular, the bank could include three optical microscanning systems which respectively emit red, green, and blue light.

An optical microscanning system can be implemented for countering terrorism by detecting known compounds known to be associated with one or more chemical or biological weapon. For example, the optically pumped light source could be adapted to emit a beam of ultraviolet radiation selected for the property of causing the known compound to emit a known characteristic sheen in optical response to being struck by the selected ultraviolet radiation.

This disclosure also provides a method of manufacturing an optical microscanning system for selectively emitting a highly coherent, collimated, and monochromatic beam of light in a desired trajectory and selectively redirecting the trajectory within a scan field. A cavity is etched in a base substrate, wherein a fixed light source is provided at the floor of the cavity. Two electrodes are provided at the floor of the cavity for electrically pumping the fixed light source. A second layer is provided over the mouth of the cavity. A mirror layer is bonded onto the second layer. Spacers are etched through the mirror layer and second layer to define a substrate section of the second layer and enable the substrate section to move with a desired degree of freedom within a scan range. The mirror layer is etched to define a mirror.

The cavity in the base substrate can be etched using reactive ion etching. The electrodes may be isolated from the floor of the cavity by provision of intervening isolators, which can be composed of silicon dioxide placed by plasma enhanced chemical vapor deposition. The two electrodes can be composed of polysilicon placed upon the isolators by means of plasma enhanced chemical vapor deposition.

The depth to which the cavity is etched in the base substrate can be selected based on the anticipated effects of an air film within the cavity on the movement of the mirror in order to enable accurate and precise movement of the mirror. The mirror layer and the second layer can be etched to define hinges within the second layer that are connected to the substrate section to enable the substrate section to scan according to an axis coaxial with the hinges, and the substrate section and hinges can be composed of single-crystal phosphorous-doped silicon.

Other aspects, objectives and advantages of the invention will become more apparent from the remainder of the detailed description when taken in conjunction with the accompanying drawings.

An electrically pumped light source (EP light source) is mounted below a bare silicon cavity and aligned and oriented so that its emitted light output will pump an optically pumped light source (OP light source). The resulting structure enables the integrated light source's output beam to be selectively directed by scanning the OP light source.

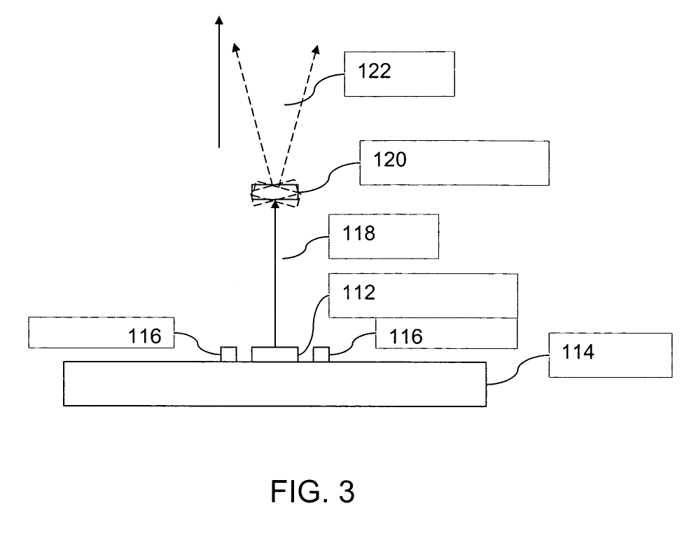

FIG. 3 schematically depicts an example of such an integrated light source. An EP light source 112 is mounted on a substrate 114. Two electrodes 116 flank the EP light source 112. When the electrodes 116 are provided with a sufficient voltage differential, the resulting electrical static force between the electrodes causes the EP light source to emit light 118. The EP light source 112 is located and oriented relative to an OP light source 120 so that EP light 118 pumps the OP light source 120, causing the OP light source 120 to emit a beam of highly coherent, collimated, and monochromatic light 122. The OP light source 120 is suspended above the EP light source 112 and configured for selectively modifying its output light trajectory by scanning.

The EP laser is preferably a vertical cavity surface emitting laser (VCSEL). More preferably, it comprises stacks of aluminum gallium arsenide and gallium arsenide substrates and emits an output light beam to which silicon is transparent. Most preferably, it includes indium gallium arsenide and emits a beam having a 1.3 micron wavelength.

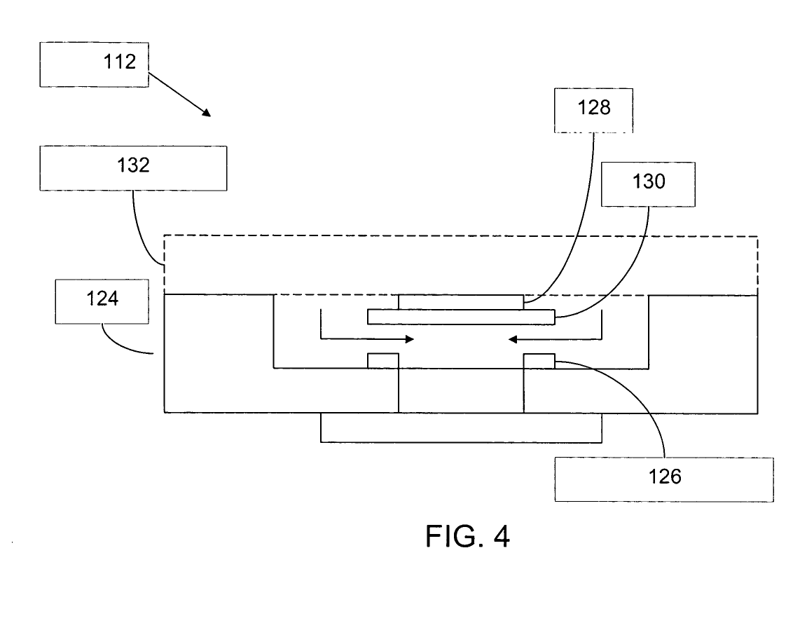

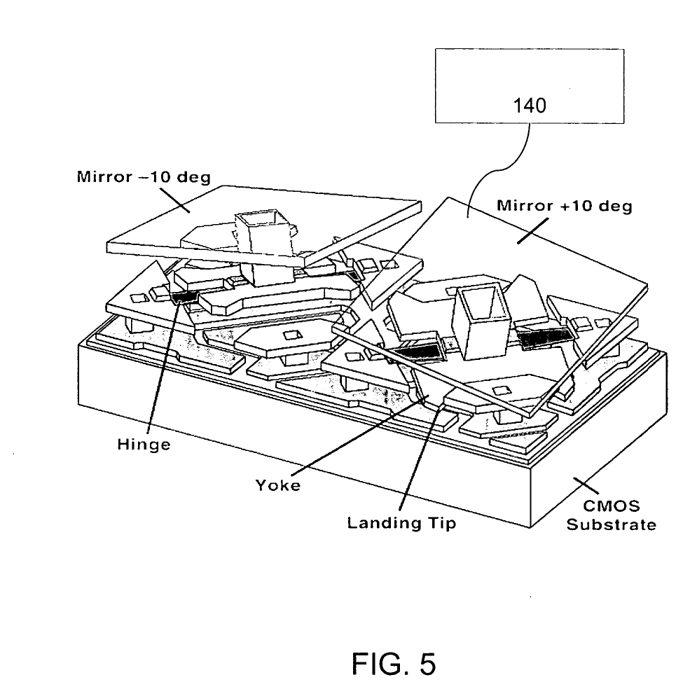

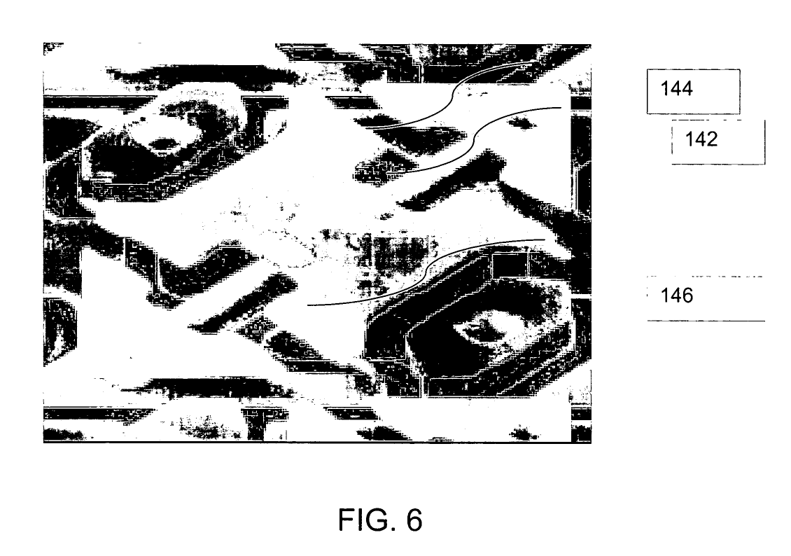

FIG. 4 shows a cross-sectional schematic view of an exemplary EP light source 112. A cavity-etched silicon substrate 124 provides the primary foundation upon which two electrodes 126 are mounted for electrically driving the EP light source. A laser 128 having a mirror 130 is incorporated for the emission of highly coherent, collimated, and monochromatic electromagnetic radiation. Finally, a silicon substrate 132 to be etched is placed over the cavity.

In one embodiment, the scanning mechanism includes a hinge allowing scanning along a single axis. In another embodiment, the scanning mechanism includes mutually orthogonal hinges allowing scanning according to two axes. Use of a two-gimbal mechanism would be one implementation of a two-axis scanning mechanism.

The movement of the suspended OP light source will be selected based on the intended application. The movement may be steady state, oscillatory, etc. Combinations and variations will be appreciated by those skilled in the art; for instance, the OP light source may be scanned according to two axes, oscillating at a different frequency with respect to each axis, producing a sinusoidal output pattern.

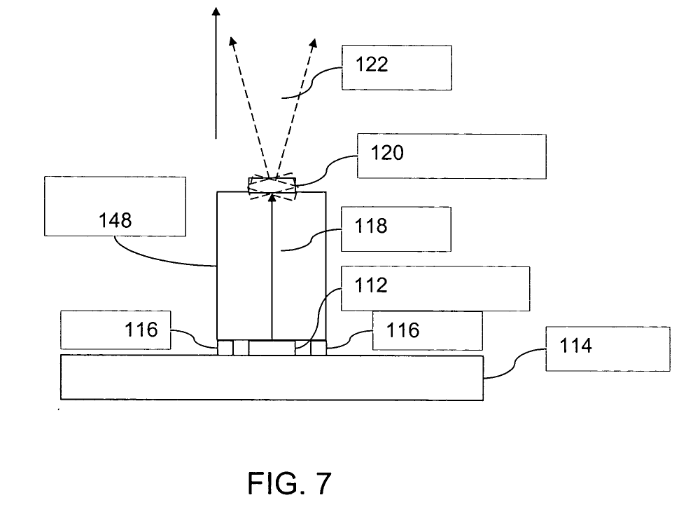

FIG. 7 shows an exemplary implementation of two scanning mechanisms as are employed by some embodiments of the present invention. The scanning mechanisms are shown sharing a single CMOS substrate. Each mechanism is capable of articulation according to a single axis defined by a hinge. The yoke of each mechanism includes four landing tips—a pair of which serves to limit the scanning range to ten degrees in each direction. The scanning mechanisms are shown having mirrors 140 rather than OP light sources, but they are operationally suitable for scanning OP light sources as described.

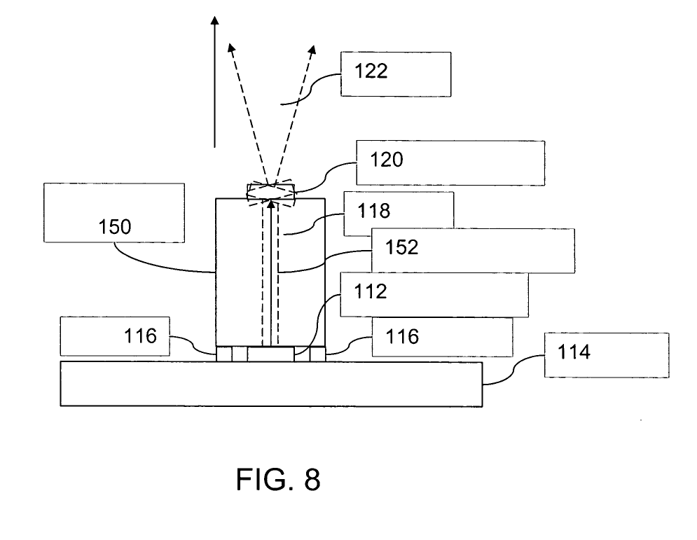

FIG. 8 is a view obtained by a scanning electron microscope of a scanning mechanism including a hinge, yoke, and landing tips. The mechanism is similar to those depicted in FIG. 7, except that no mirror or OP light source is shown, having been omitted for clarity.

One reason that the preferred OP light source is not electrically pumped is because connecting traces to it could interfere with its ability to micromechanically scan with accuracy. By contrast, optical pumping does not impair its ability to scan because incoming light does not appreciably affect its micromechanical scanning structures.

In general, lasers can be pumped electrically or optically. In the preferred embodiment, an EP laser is used to pump an OP laser. However, those of skill in the art will understand that the role of the EP laser could readily be fulfilled by a second OP laser, and such would be within the scope of the appended claims.

In the preferred embodiment, a spacer is utilized between the EP light source and the OP light source in order to fix their relative positions. FIG. 7 illustrates the placement and operation of such a spacer 148. The spacer 148 must allow the beam 118 emitted by the EP light source 112 to pump the OP light source 120. One means to accomplish this result is by composing the spacer 148 of material sufficiently transparent to the beam 118 emitted by the EP light source 112. Silicon is transparent to infrared light. Quartz, diamond, and Pyrex® are transparent to visible light.

FIG. 8 depicts an alternate approach wherein a spacer 150 is composed of an opaque material. A hole 152 is machined through the spacer 150, allowing sufficient light 118 from the EP light source 112 to pump the OP light source 120. Machining such a hole is a practical alternative because industry precision in such applications is on the order of 2 microns, while the die used in the preferred embodiment is on the order of 100 microns across.

In the preferred embodiment, the wavelength of the light beam emitted by the EP light source is relatively shorter than the wavelength of the light beam emitted by the OP light source, conforming to conventionally accepted understanding of the natural laws which govern optically pumped lasers. In essence, the light emitted by the OP light source reflects stimulated emission of photons from electrons within the OP light source. In particular, the light reflects an increase in energy (E) that results from electrons within the OP light source being reduced (h) from one energy level to a relatively lower energy level, according to Planck's Law:
E=h/λ,
where λ is the wavelength of the emitted light.

Such stimulated emission requires that the pumping light be of shorter wavelength than the emitted light. In an exemplary embodiment which emits an infrared light beam, the EP light source emits a light beam having a wavelength of about 850 nm, and the OP light source emits a light beam having a wavelength of about 900 nm to about 1300 nm. In another exemplary embodiment, the EP light source emits ultraviolet light with a wavelength within the range of about 280 nm to 300 nm, and the OP light source emits a visible light beam. Visible light falls within the wavelength range of about 400 nm to about 650 nm.

An exemplary embodiment emits light having a wavelength within the visible light spectrum corresponding to the color red. The same device can be made to emit a light beam having a shorter wavelength by passing the beam through a frequency doubling crystal composed of quartz, Pyrex®, glass, or other suitable transparent material that will shorten the beam's wavelength. A variety of conventional means are available for modifying the wavelength of the light output beam to correspond to a different color within the spectrum of visible light. Alternately, diamond can be used.

Infrared and red do not need to be channeled because of absorption. Green/Blue need quartz, Pyrex®, or any glass transparent to visible light (optically transparent material). Alternately, if the material is not inherently transparent to visible light, micromachining small holes in the material makes it suitable for channeling visible light down to a shorter wavelength.

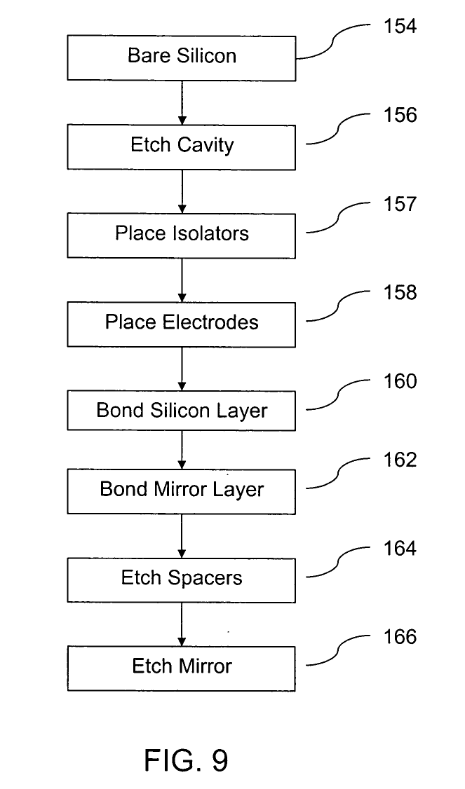

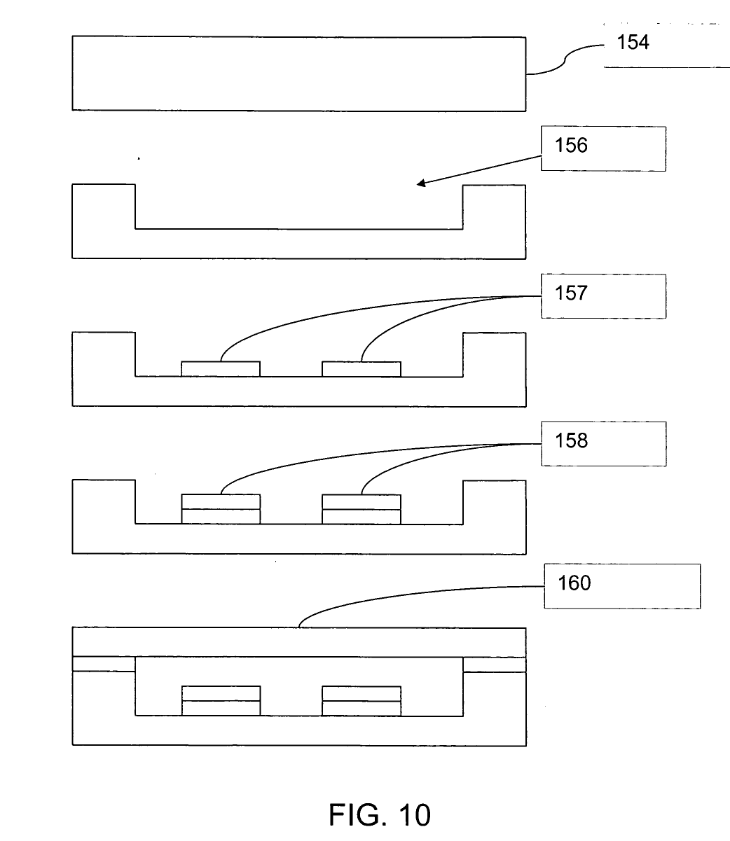

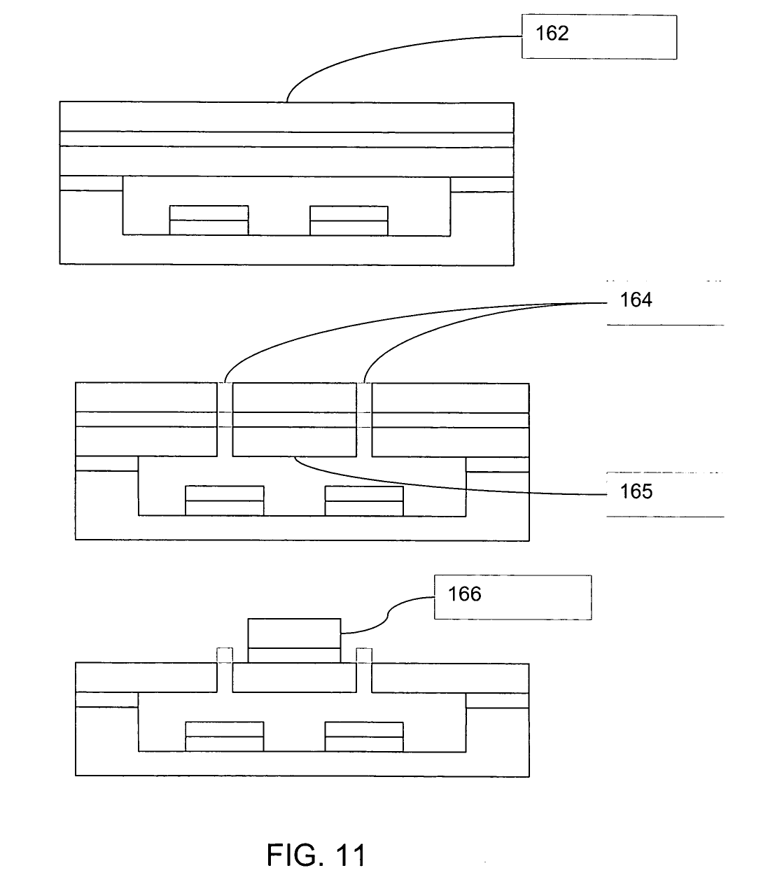

FIGS. 9, 10, and 11 depict a preferred method of manufacturing a preferred embodiment of the present invention. FIG. 9 depicts the method using flowchart symbols, while FIGS. 10 and 11 depict the method using schematic representations. A substrate is provided 154. The substrate 154 is preferably composed of bare single-crystal silicon, but could alternately be composed of any suitable material, such as gallium arsenide. A cavity is etched 156 in the substrate. Preferably, a reactive ion etch is performed. Those skilled in the art will appreciate that, although specific techniques and materials are identified throughout this application in describing embodiments of the present invention, various other techniques and materials could alternately be used without departing from the spirit and scope of the present invention. For example, the cavity in the bare silicon is preferably created using a reactive ion etch process, but those of skill in the art will appreciate that alternate semiconductor processing techniques could be used: the cavity could be created using another dry etch technique or even a suitable wet etch technique or combination of known techniques.

Isolators are then placed 157 in the floor of the cavity in preparation for mounting the two electrodes which will stimulate the EP light source to emit a beam of light. Preferably, the isolators are silicon dioxide placed by plasma enhanced chemical vapor deposition. Electrodes are mounted 158 upon the isolators. It is preferable that the electrodes be composed of polysilicon and mounted by means of plasma enhanced chemical vapor deposition.

A silicon layer is then mounted 160 on the bare silicon over the mouth of the etched cavity. The depth of the cavity etched in the bare single-crystal silicon is selected to coordinate with the MEMS mirror of the OP light source to achieve timely and accurate movement of the mirror taking into account the compressive effects such movement has upon the thin air film within the cavity. Preferably, the layer is composed of silicon and fusion bonded using thermal pressure to the bare silicon with silicon dioxide. Such bonding typically entails first growing a small layer of silicon dioxide on the surface to be bonded.

A mirror layer is bonded 162 onto the silicon layer, preferably by means of fusion bonding with silicon dioxide, but any suitable bonding may be utilized, such as eutectic or anodic die-to-wafer or wafer-to-wafer bonding. Spacers are then etched 164 through the mirror layer and the silicon layer to allow a substrate section 165 of the silicon layer to move with suitable freedom. A mirror is then defined by etching 166 the mirror layer. Preferably, the etchings 164, 166 are performed after the mirror is bonded 162 to avoid the risk of fracture as a result of thinner support elements resulting from the etchings 164, 166. Pre-etching can also be utilized. On a full-wafer scale, die-to-wafer bonding could be more convenient in creating a cantilever structure, and dry bonding can be utilized. The gallium nitride or silicon oxide layers can be dry or wet etched as appropriate.

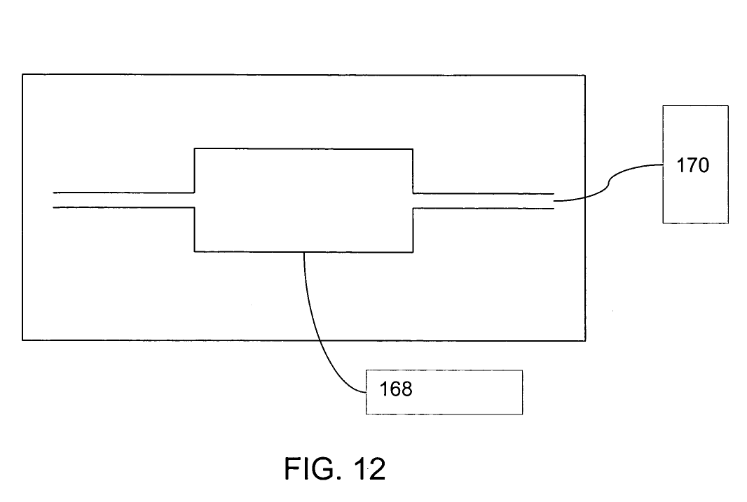

FIG. 12 shows a top view of the mirror 168 and a cantilever hinge 170 allowing the mirror to reorient or scan according to an axis defined by the hinge 170. The mirror 168 is preferably rectangular, but may be any suitable shape, whether elliptical, irregular, or otherwise. The hinge 170 is preferably composed of the same material as the mirror 168, which is preferably single-crystal N-doped silicon. More preferably, the mirror 168 is composed of phosphorus-doped silicon.

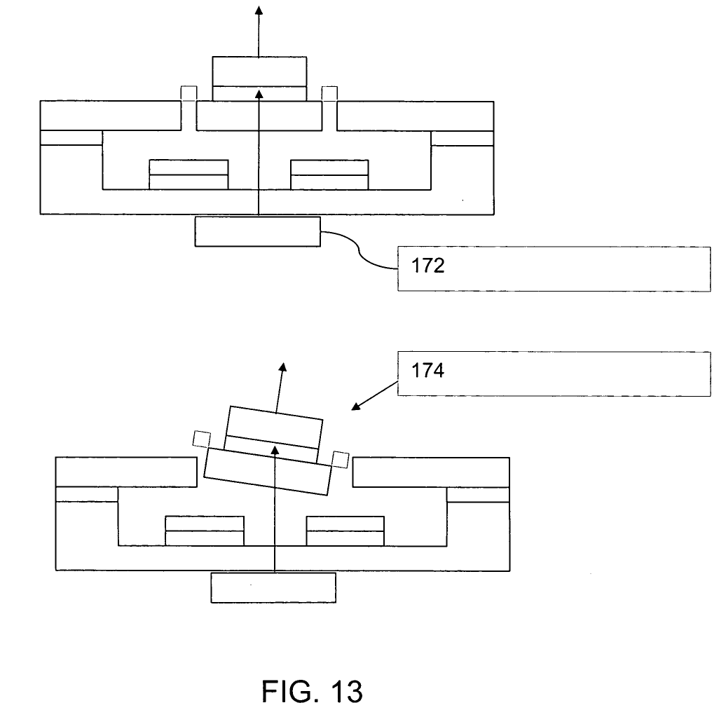

FIG. 13 shows side views of an integrated light source device resulting from the manufacturing method of FIGS. 9, 10, and 11. The EP light source 172 is shown pumping the OP light source 174, which is free to scan within its scan range.

Preferably, the entire structure of the light source of the preferred embodiment is hermetically encapsulated. The encapsulation should provide protection and a transparent window for an output beam of light.

While the dimensions of specific embodiments will vary, the dimensions of one embodiment are 2 mm×1.7 mm, and its light output beam is one mm thick. Another embodiment, including IC packaging, is approximately one cubic mm, which is a form factor improvement of at least 100 times over some of the prior art devices discussed in the background. This form factor improvement is achieved without a loss of lumens. In fact, similar, or in some cases the same, light source can be used in embodiments of the present invention. Moreover, insofar as the present invention supports embodiments having many more light sources per fixed area than prior art devices, light output intensity can actually be increased.

The scan field of a particular light source system depends upon the range of scanning available. Scan fields can be straight-line, curved-line, regular, irregular, conical, semispherical, spherical, or a combination thereof, among others. Preferably, the scan field is determined by the mechanical structure associated with scanning the OP light source. For example, the scan field of a two-axis implementation approaches semispherical as the scan field of each axis approaches 180 degrees. Two such two-axis light sources combined in back-to-back fashion, each having substantially semispherical scan fields would have a substantially spherical combined scan field.

Alternately, two light source systems having differing scan fields could be coordinated. For instance, two such light sources could be connected back-to-back to establish an irregular scan field having at least two differing yet interrelated scan field portions. Yet other alternative implementations include configurations of more than two light sources.

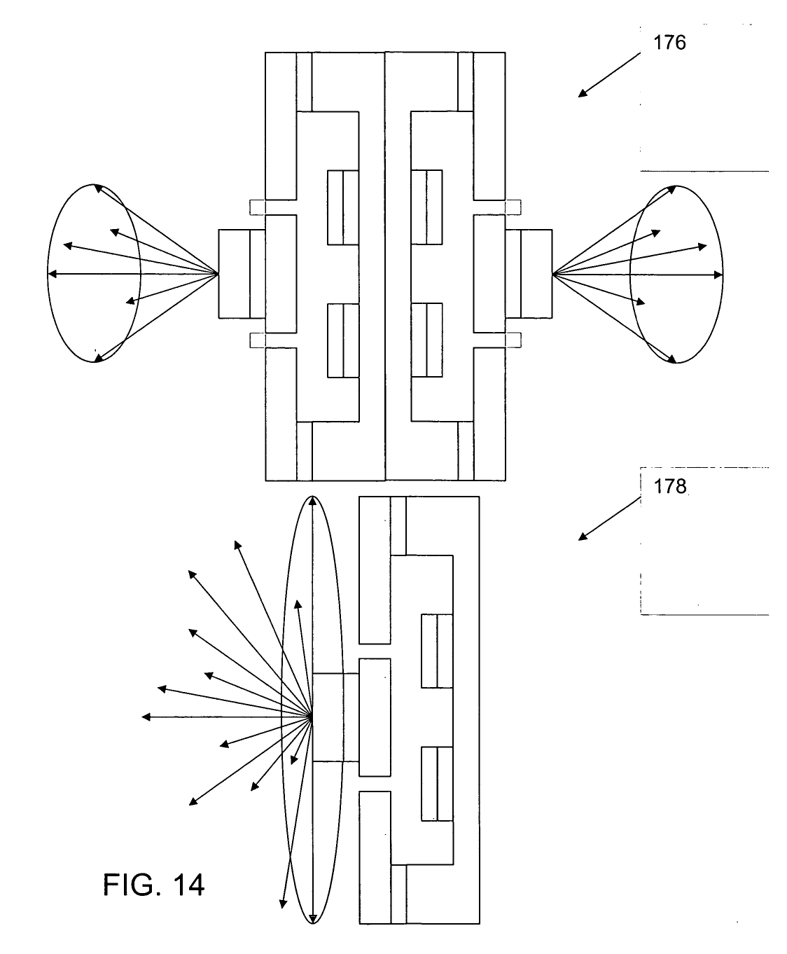

FIG. 14 shows two exemplary scan field cases. The first scan field case 176 includes two integrated light source devices configured back-to-back, each having a conical scan field. The second scan field case 178 includes an integrated light source device having a semispherical scan field.

Heat management and dissipation issues are reduced for the preferred embodiment by virtue of the fact that optical pumping generates an extremely low amount of heat relative to electrical pumping. The electrodes controlling the micromirror of the OP light source do not create heat issues because they are capacitive and therefore free from current flow.

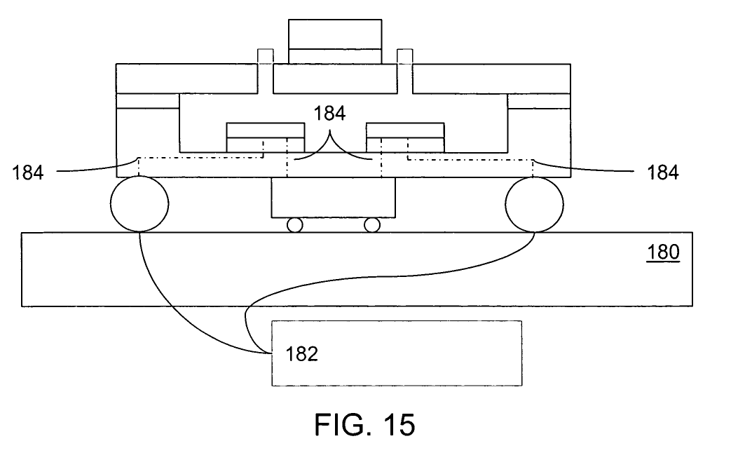

As shown in FIG. 15, the control mechanism for operating the integrated light source device is preferably control circuitry, most preferably an application specific integrated circuit (ASIC) 180. In the preferred embodiment, conventional ball connectors 182 provide electric current to the electrodes via traces 184. The mirror associated with the OP light source in the preferred embodiment is driven by conventional means including electrodes (not shown) which are also provided with current from the ASIC through conventional ball connectors.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing embodiments of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The term “photo pump,” as used herein, means optically pump.

The term “light,” as used herein, means visible or invisible electromagnetic radiation of any wavelength that is, to a high degree, collimated, coherent, and monochromatic.

The term “scan,” as used herein, encompasses redirection of an emitted beam of light. For example, preferred embodiments of the present invention can sweep an emitted beam of light according to one or more axes. The angular range within which a device can scan an emitted beam of light is herein called its “scan field.”

Preferred embodiments of this invention are described herein, including the best mode for carrying out the invention. Variations of those preferred embodiments may become apparent to those of ordinary skill in the art upon reading the foregoing description. Skilled artisans are expected to employ such variations as appropriate and to practice the invention otherwise than as specifically described herein. For example, some arrangements of multiple integrated light sources have been described, but many more arrangements will be apparent to those having skill in the art. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An optical microscanning system for selectively emitting a highly coherent, collimated, and monochromatic beam of light in a desired trajectory and selectively redirecting the trajectory within a scan field, the system comprising:
a fixed light source of substantially coherent, collimated, and monochromatic light;
an optically pumped light source of highly coherent, collimated, and monochromatic light;
wherein the optically pumped light source is relatively positioned and configured to be optically pumped by the highly coherent, collimated, and monochromatic light output of the fixed light source; and
wherein the optically pumped light source has a scan range within which it is adapted to be scannably reoriented in order to selectively redirect the highly coherent, collimated, and monochromatic light it emits.

2. The optical microscanning system according to claim 1, wherein the fixed light source comprises a vertical cavity surface emitting laser.

3. The optical microscanning system according to claim 2, wherein the vertical cavity surface emitting laser comprises stacks of aluminum gallium arsenide and gallium arsenide substrates and is configured to emit a beam of light to which silicon is transparent.

4. The optical microscanning system according to claim 3, wherein the vertical cavity surface emitting laser further comprises indium gallium arsenide and is configured to emit a beam of light having a 1.3 micron wavelength.

5. The optical microscanning system according to claim 1, further comprising a scanning mechanism defining the scan range of the optically pumped light source according to a single axis of reorientation.

6. The optical microscanning system according to claim 5, wherein the scanning mechanism further defines the scan range of the optically pumped light source according to a second axis of reorientation.

7. The optical microscanning system according to claim 1, further comprising a spacer located between the fixed light source and the optically pumped light source for fixing the relative positions of the fixed and optically pumped light sources.

8. The optical microscanning system according to claim 7, wherein the spacer comprises a material transparent to the substantially coherent, collimated, and monochromatic light emitted by the fixed light source.

9. The optical microscanning system according to claim 7,
wherein the spacer comprises a material opaque to the substantially coherent, collimated, and monochromatic light emitted by the fixed light source; and
wherein the spacer defines a hole through which the substantially coherent, collimated, and monochromatic light emitted by the fixed light source can pass to pump the optically pumped light source.

10. A bank of optical microscanning systems, comprising:
a plurality of optical microscanning systems according to claim 1; and
wherein each optical microscanning system is configured to emit a highly coherent, collimated, and monochromatic light having a different wavelength.

11. The bank of optical microscanning systems according to claim 10, wherein the plurality of optical microscanning systems according to claim 1 comprises:
three optical microscanning systems according to claim 1, wherein a first system is configured to emit red light, a second system is configured to emit green light, and a third system is configured to emit blue light.

12. The optical microscanning system according to claim 1, adapted for countering terrorism by detecting a known compound,
wherein the optically pumped light source is adapted to emit a beam of ultraviolet radiation selected for the property of causing the known compound to emit a known characteristic sheen in optical response to being struck by the selected ultraviolet radiation.

13. A method of manufacturing an optical microscanning system for selectively emitting a highly coherent, collimated, and monochromatic beam of light in a desired trajectory and selectively redirecting the trajectory within a scan field, the method comprising the steps of:
etching a cavity in a base substrate, wherein a fixed light source is provided at the floor of the cavity;
providing two electrodes at the floor of the cavity for electrically pumping the fixed light source;
providing a second layer over the mouth of the cavity;
bonding a mirror layer onto the second layer;
etching spacers through the mirror layer and second layer to define a substrate section of the second layer and enable the substrate section to move with a desired degree of freedom within a scan range; and
etching the mirror layer to define a mirror.

14. The method of manufacturing an optical microscanning system according to claim 13, wherein the step of etching the cavity in the base substrate comprises the step of:
reactive ion etching the cavity in the base substrate.

15. The method of manufacturing an optical microscanning system according to claim 13, further comprising the step of:
providing two isolators at the floor of the cavity for isolating the electrodes.

16. The method of manufacturing an optical microscanning system according to claim 15, wherein the step of providing two isolators comprises the step of:
providing two isolators composed of silicon dioxide placed by plasma enhanced chemical vapor deposition.

17. The method of manufacturing an optical microscanning system according to claim 16, wherein the step of providing two electrodes comprises the step of:
providing two electrodes composed of polysilicon placed upon the isolators by means of plasma enhanced chemical vapor deposition.

18. The method of manufacturing an optical microscanning system according to claim 13, wherein the step of etching the cavity in the base substrate comprises the step of:
etching the cavity in the base substrate to a selected depth based on the anticipated effects of an air film within the cavity on the movement of the mirror in order to enable accurate and precise movement of the mirror.

19. The method of manufacturing an optical microscanning system according to claim 13, further comprising the step of:
etching the mirror layer and the second layer to define hinges within the second layer that are connected to the substrate section to enable the substrate section to scan according to an axis coaxial with the hinges.

20. The method of manufacturing an optical microscanning system according to claim 19, wherein the substrate section and the hinges are composed of single-crystal phosphorous-doped silicon.
